(19) United States
(12) Patent Application Publication
(10) Pub. No.: US 2003/0120907 A1
(43) Pub. Date: Jun. 26, 2003

(54) Automatic keyboard BIOS updating method

(76) Inventor: Chih-Chien Tang, Taipei (TW)

Correspondence Address: BIRCH STEWART KOLASCH & BIRCH, PO BOX 747, FALLS CHURCH, VA, 22040-0747, US

(21) Appl. No.: 10/023,816

(22) Filed: Dec. 21, 2001

(51) Int. Cl. G06F 15/177

(52) U.S. Cl. 713/1

(57) ABSTRACT

An automatic keyboard BIOS undating method utilizes the updating keyboard BIOS in the Firmware Hub to update the keyboard BIOS system of keyboard control. It comprises the steps of: setting up at least one updating control key; adding a distinguishing signal and an updating instruction to the Boot block of the keyboard BIOS, with the former used to distinguish the updating control key; pressing at least one updating control key to send out the updating control message; the system executing the updating instruction; deleting the keyboard BIOS; updating the keyboard BIOS and saving it in the control unit.

### BACKGROUND OF THE INVENTION

1. Field of the Invention

The invention relates to an automatic updating method of the keyboard basic input output system (BIOS), which is mainly used in the updating the BIOS of computer systems.

2. Related Art

When a computer is started, the computer system first tries to find the basic input output system (abbreviated below as BIOS) program. After executing the BIOS program, the computer system enters the starting procedure. The BIOS is a kind of firmware, which is a hardware device with a program code between software and hardware. When a computer is started, the BIOS performs tasks such as initialization implementation and parametric transfer to all the peripheral equipment.

The operation of the BIOS is shown in FIG. 1, the structure diagram of a common computer system. The central processing unit 10 connects to the north Bridge (a group of chips) 30 via the CPU Bus 20. However, the north Bridge 30 does not only connect to the memory 40 (which can be SDRAM, RDRAM, etc), but also connects to the AGP VGA 60 by the AGP Bus 50. Moreover, the north Bridge 30 also connects with the south Bridge (another group of chips) 80 via the PCI Bus 70, in order to send data and messages. The south Bridge 80 that connects with the hard disk 90, tile universal serial Bus (USB) 100, and the input device 110 (such as a mouse, a keyboard, etc.), is used to store and input data. It also connects with the system BIOS 140 and the audio frequency unit 150, via the XD Bus 120 and the ISA Bus 130 separately.

It can be clearly understood from FIG. 1 that the system BIOS 140 can connect with other peripheral equipment via the XD Bus 120 and the south Bridge 80. Therefore, a computer can work normally after all peripheral equipment is initialized. However, because the BIOS code may be damaged, new kinds of BIOS have been developed. Moreover, the companies of computer systems always provide new versions of BIOS, so it also creates the demands of updating BIOS. These demands can be met by the development of Random Access Memory (RAM), such as Flash memory. Accordingly, the BIOS is written in Flash memory nowadays. Therefore, the current BIOS can be updated simply by software, or be updated via the network.

The keyboard BIOS, which is a part of the BIOS, also needs to be updated. Currently, there is one way to update the keyboard BIOS from Firmware Hub (FWH). Its diagram (shown in FIG. 2) has the same framework and connection as FIG. 1. Please refer to FIG. 3, which is a flowchart illustrating conventional methods of keyboard updating. The FWH 160 comprises a 64 kilobit system BIOS and a keyboard BIOS. The keyboard BIOS can be used as a spare. The keyboard BIOS is saved in the Flash ROM of the keyboard control 170 (below abbreviated as KBC) during keyboard operation. When a computer is started, the system compares the keyboard BIOS in FWH160 and the keyboard BIOS FWH170 (step 210). If there is any difference, the version of keyboard BIOS in FWH170 should be changed to the version of BIOS in FWH160.

The keyboard BIOS in FWH160 can be used as a spare, so one need not worry if the keyboard BIOS in FWH170 is destroyed. It can be replaced and updated quickly and easily. However, this method also has its drawbacks. If the computer system cannot distinguish the version of the keyboard BIOS in FWH160 and FWH170, the keyboard BIOS can not be updated.

### SUMMARY OF THE INVENTION

The invention provides a kind of automatic updating method of the keyboard BIOS. It can update the keyboard BIOS through a simple user operation. The users only need to press the specific function key to finish the keyboard BIOS updating immediately. The automatic keyboard BIOS updating method in the invention utilizes the updating keyboard BIOS in the Firmware Hub, to update the keyboard BIOS system of keyboard control. It comprises the steps of: set up at least one updating control key; add a distinguishing signal and an updating instruction to the Boot block of the keyboard BIOS, with the former used to distinguish the updating control key; press at least one updating control key to send out the updating control message; the system executes the updating instruction; delete the keyboard BIOS; update the keyboard BIOS and save it in the control unit.

The invention also considers the case when the user does not operate the updating control key. The computer system itself will judge whether the version of this keyboard BIOS is different from the updated one.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a diagram of normal computer systems;

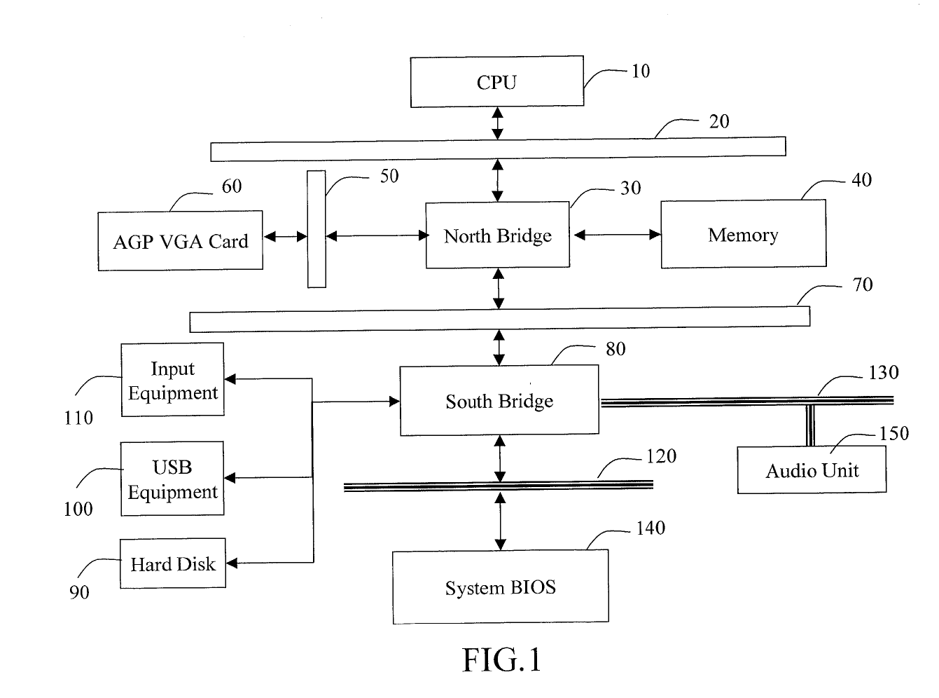

FIG. 2 is a flowchart of the conventional keyboard BIOS updating method;

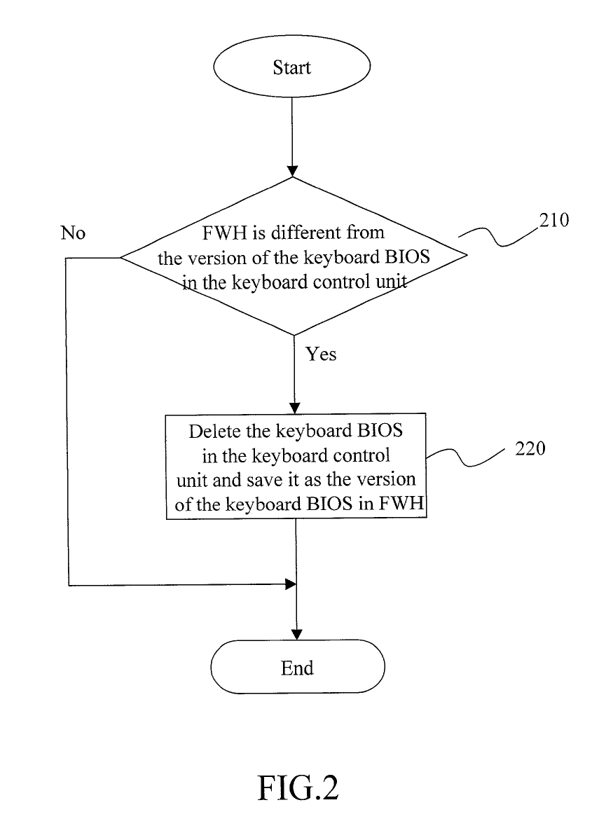

FIG. 3 is a diagram of normal computer systems using prior keyboard BIOS updating method;

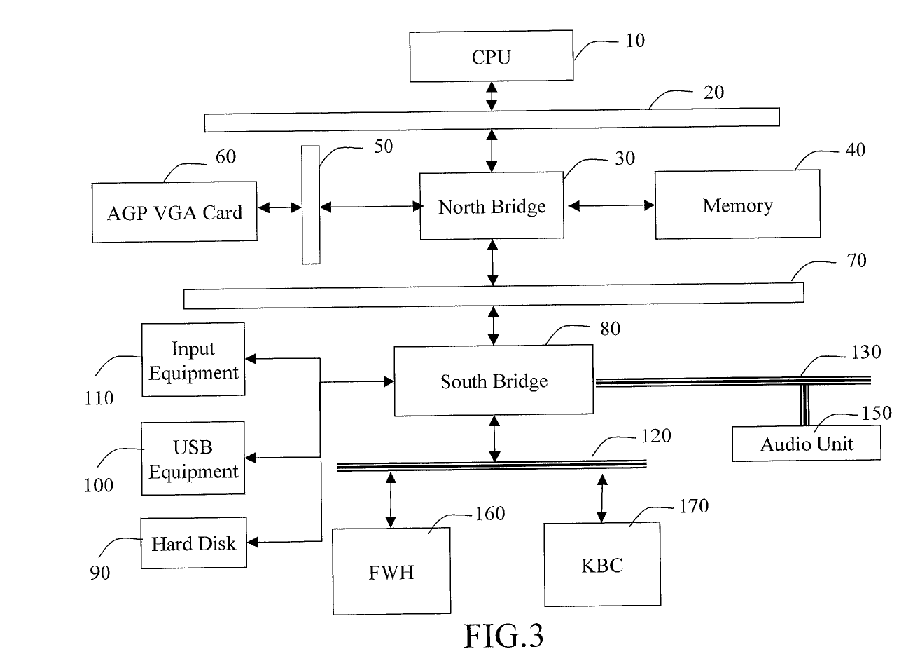

FIG. 4 is a diagram of the keyboard BIOS updating method disclosed in the invention; and

FIG. 5 is a flowchart of the automatic keyboard BIOS updating method disclosed in the invention.

### DETAILED DESCRIPTION OF THE INVENTION

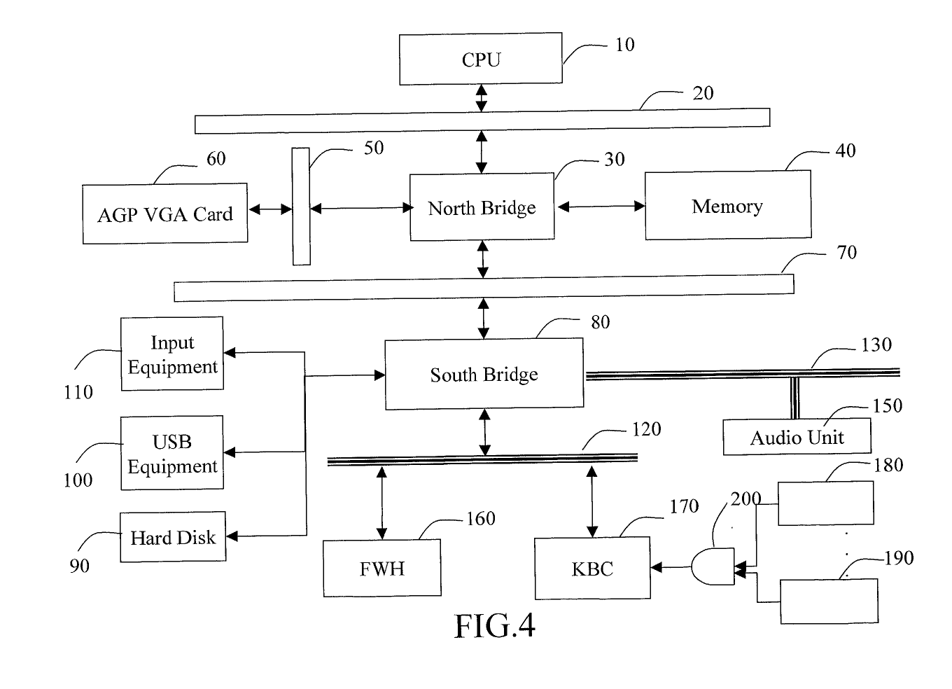

The updating operation of the keyboard BIOS in the invention is shown in FIG. 4, which is a diagram of computer systems for the keyboard updating method.

In FIG. 4, the central processing unit 10 connects with the north Bridge 30 (a group of chips) via the CPU Bus 20. However, the north Bridge 30 does not only connect with the memory 40, but it also connects with the AGP VGA 60 via the AGP serial Bus 50. Moreover, the north Bridge 30 also connects with the south Bridge 80 (another group of chips) via the PCI serial Bus 70, in order to send data and messages. The south Bridge 80, which connects with the hard disk 90, the universal serial Bus 100 (USB), and the input device 110 (such as a mouse, a keyboard, etc.), is used to save and input data. It also connects with the Firm Ware Hub (FWH) 160 and the keyboard control unit (KBC) 170 via the XD serial Bus 120 and the ISA serial Bus 130 separately. The KBC 170 can exist in the KAHUNA system or super BIOS in Flash ROM. The figure also shows several updating control keys 180-190. The control keys can be LID_SW key or STB_SW key, depending on users.

Once the user presses the updating control keys 180 and 190 simultaneously, both signals can be sent jointly as an updating control message to the KBC 170 via the AND gate 200. This can update the keyboard BIOS in KBC 170 into the keyboard BIOS in KBC160. Updating the refreshing control keys 180˜190 can be set up beforehand. And, if only the distinguishing signal is able to determine whether the updating control key 180˜190 is added to the KBC 170 in advance, the updating instruction of keyboard BIOS will be started when users press the updating control keys 180˜190.

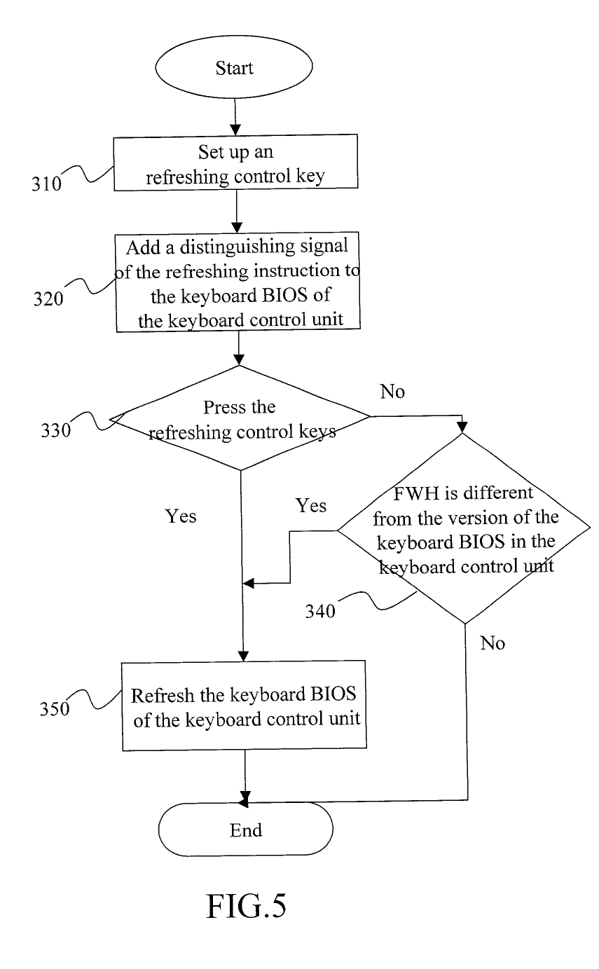

FIG. 5 is a flowchart of the automatic updating method of the keyboard BIOS disclosed in the invention, and one should also refer to FIG. 4.

The automatic keyboard BIOS updating method in the invention utilizes the updating keyboard BIOS in the Firmware Hub 160 to update the keyboard BIOS system of the KBC 170. It comprises the steps of: setting up at least one updating control key 180˜190 (step 310); adding a distinguishing signal and an updating instruction to the Boot block of the keyboard BIOS, with the former used to distinguish a plurality of updating control keys and execute the updating instruction (step 320); pressing at least one of these updating control keys (step 330); when the user is not operating the updating control key, the computer system itself determining whether the version of this keyboard BIOS is different from the updated one (step 340); and finishing the updating of the keyboard BIOS of the keyboard control unit (step 350).

In the automatic keyboard BIOS updating method in the invention, the BIOS engineer first sets up at least one of these updating control keys (step 310). These keys can be LID_SW (lid switch) key or STB_SW (stand by switch) key.

Then, the BIOS engineer sets up the distinguishing signal for a plurality of selected updating control keys, and adds the refreshing instruction to the Boot block of the keyboard BIOS. When the BIOS distinguishes the updating control message sent by the updating control key, the computer system executes the updating instruction (step 320).

Therefore, when the user presses one of these updating control key (step 330), the keyboard BIOS can distinguish the updating control message sent by the updating control key, and send out the updating instruction. So, the computer system can execute this instruction, and update the keyboard BIOS of the keyboard control unit (step 350). When the keyboard BIOS executes the updating instruction, the computer system deletes the old keyboard BIOS and saves the updated one in the keyboard control unit.

If the user does not use the updating control key, it will be handled by the conventional keyboard BIOS updating method. That is, the computer system itself will determine whether the keyboard BIOS is the same as the new version (step 340). If they are the same, there will be no change; if they are different, the keyboard BIOS will be updated (step 350). In other words, the keyboard BIOS will execute the updating instruction, delete the old keyboard BIOS, update it, and save it in the keyboard control unit.

The keyboard control unit disclosed in the invention is the super BIOS or KAHUNA system.

The technique disclosed in the invention can allow the system to be updated by simple operation of the keyboard BIOS. Users can complete the updating work immediately by pressing the specific function key.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A keyboard BIOS updating method uses a updating keyboard BIOS in a Firmware Hub of a system to update a keyboard BIOS of a keyboard controller, which comprises the steps of:
setting up at least one updating control key;
adding a distinguishing signal and an updating instruction to the Boot block of the keyboard BIOS, the distinguishing signal used to distinguish the updating control key;
pressing at least one updating control key to send out the updating control signal;
and
executing the updating instruction, deleting the keyboard BIOS, updating the updating keyboard BIOS and savings aid updating keyboard BIOS in the keyboard controller.

2. The updating method of keyboard BIOS of claim 1, wherein the keyboard controller is a super BIOS.

3. The updating method of keyboard BIOS of claim 1, wherein the updating control key are LID_SW ( lid switch ) key or STB_SW ( stand by switch ) key.

4. The updating method of keyboard BIOS of claim 1, wherein said keyboard BIOS sends said updating instruction according to the distinguishing signal and distinguishes the updating control signal pressed by the user.

5. The updating method of keyboard BIOS of claim 1, wherein after the step of adding an refreshing instruction to the Boot block of the keyboard BIOS, further comprises the step of:
determining whether said keyboard BIOS and said updating keyboard BIOS are the same by said system when user presses at least one of said updating control keys.

6. The updating method of keyboard BIOS of claim 4, wherein the system deletes the keyboard BIOS and saves the updating keyboard BIOS when the system determines the keyboard BIOS is different from the updating keyboard BIOS.

7. The updating method of keyboard BIOS of claim 1, wherein the keyboard BIOS is deleted and the refreshing keyboard BIOS is saved in the keyboard controller when the BIOS executes the refreshing instruction.
